(19) United States
(12) Patent Application Publication
(10) Pub. No.: US 2025/0343739 A1
(43) Pub. Date: Nov. 6, 2025

(54) Identifying Mobile Devices Suitable for use in an Artificial Intelligence Operation

(71) Applicant: Telefonaktiebolaget LM Ericsson (publ), Stockholm (SE)

(72) Inventors: Mehdi Abad, Sariyer (TR); Abdulrahman Alabbasi, Kista (SE); Massimo Condoluci, Solna (SE)

(21) Appl. No.: 18/866,236

(22) PCT Filed: May 18, 2022
(86) PCT No.: PCT/TR2022/050448

§ 371 Date: Nov. 15, 2024

(51) Int. Cl. H04L 41/16; H04W 24/08

(52) U.S. Cl. CPC H04L 41/16; H04W 24/08

(57) ABSTRACT

A method, performed in a network node (110, 125), for facilitating an artificial intelligence, AI, operation (210) in a wireless access network (100), the method comprising determining (Sal) one or more data set characteristics indicative of a relevance of a data set to the AI operation (210), obtaining (Sa2) a test specification defining a test to be performed on a data set (230) of the wireless device (150), where the outcome of the test is indicative of if the data set of the wireless device (150) has the one or more data set characteristics, transmitting (Sa3) the test specification (220) to the wireless device (150), receiving (Sa4) a result of the test performed on the data set (230) of the wireless device (150) as a test outcome (240) from the wireless device (150), and verifying (Sa5) if the data set of the wireless device (150) meets an acceptance criterion for use in the AI operation, based on the received test outcome (240).

The project leading to this application has received funding from the European Union's Horizon 2020 research and innovation program under grant agreement No 101015956.

### TECHNICAL FIELD

The present disclosure relates to artificial intelligence (AI) procedures in wireless communication systems, based on data collected from one or more wireless devices, such as mobile user equipment (UE) in a third generation partnership program (3GPP) wireless access system. The disclosed methods are particularly suitable for use in 3GPP defined networks, but may also find uses in other types of networks. There are disclosed methods, network nodes, and wireless devices, as well as computer programs and computer program products configured for facilitating both configuration and execution of AI procedures in wireless communication systems.

### BACKGROUND

The use of AI in wireless communication systems is increasing. AI has been proposed for network optimization such as communications resource provisioning and antenna configuration, as well as for network monitoring, i.e., the inference of network status and the detection of various events and anomalies in the network. Methods involving aspects of AI have also been proposed for event prediction in wireless access networks, allowing pre-emptive countermeasures to mitigate the consequences of undesired events before they occur or take maximum advantage of desired events about to take place.

AI procedures normally comprise training of some form of computational structure, such as a neural network or a random forest structure, based on training data. Training may be performed in an initial stage and then terminated when a convergence criterion has been reached, or performed continuously, whereby the AI structure is adapted over time so as to stay relevant as the operating conditions of the function changes.

The data used for training an AI structure of course has an impact on the end performance of the function. Unless the structure is trained in the right way, and using the right type of data, the capability of the structure to perform the intended function will suffer Using the wrong type of data may also prolong the convergence time of the AI structure, and may place unnecessary load on communications resources in a wireless system.

The term AI will be used herein to denote any form of trained adaptive method which uses training data to configure or define a function which can then be used for tasks such as classification, inference, configuration optimization, and the like. The term AI is consequently to be interpreted broadly herein. In particular, no specific distinctions will be made between methods normally referred to as machine learning (ML) and AI.

A lot of effort has gone into UE selection for use in gathering input data to AI various procedures, both during training and execution phases. Proposals have focused on the processing capability of the UEs, aspects such as state of charge (SOC) of the UE battery, and the data rates obtainable by the UE.

3GPP TR 22.874 (V18.2.0, 2021 Dec. 24) covers use cases and potential requirements for 3GPP fifth generation (5G) system support of AI functions. Aspects related to selection of UE in Federated Learning (FL) approaches for model update is touched upon.

3GPP contribution R3-215270, i.e., “AI/ML based mobility optimization”, Intel Corporation, TSG-RAN WG3 Meeting #114-e, November 2021, considers aspects of UE selection for AI-based network functionalities.

However, despite the work done to-date, there is a continuing need for methods that make AI procedures executed in wireless communication systems more efficient and robust. There is a further need for techniques which make AI operations performed in wireless communication systems more efficient, in particular with respect to communication overhead.

### SUMMARY

It is an object of the present disclosure to provide methods and devices for facilitating AI operations in wireless communication networks, such as training AI structures and executing AI functions as well as providing functions that make important information related to available data sets in the network available to other network functions and entities. This object is at least in part obtained by a method, performed in a network node, for facilitating an AI operation in a wireless access network. The method comprises determining one or more data set characteristics indicative of a relevance of a data set to the AI operation, obtaining a test specification defining a test to be performed on a data set of the wireless device, where the outcome of the test is indicative of if the data set of the wireless device has the one or more data set characteristics, transmitting the test specification to the wireless device, receiving a result of the test performed on the data set of the wireless device as a test outcome from the wireless device, and verifying if the data set of the wireless device meets an acceptance criterion for use in the AI operation, based on the received test outcome. This way the network node, e.g., a radio base station or a processing function in a core network, may acquire information related to the relevance of a data set at the wireless device with respect to an AI operation to be performed at least in part by the network node. By examining the test outcome, the network node can decide, e.g., whether to involve the wireless device in the AI procedure or to skip using the wireless device and instead focus on other wireless device that are deemed more relevant to the AI operation. Thus, the handling of AI operations in the wireless access network becomes more efficient, since more relevant data sets can be identified for use in the AI operation. The method may also comprise performing at least part of the AI operation and/or instructing the wireless device to perform at least part of the AI operation, conditioned on that the data set of the wireless device meets the acceptance criterion. It is, however, noted that the method can also be used for other technical purposes, such as gathering information from the network, updating network functions, refreshing databases in the wireless access system, and the like. The methods disclosed herein can for instance be used to provide a service which other network functions and entities can make use of when desiring to execute some type of AI procedure. The relevance of the data set to the AI operation can relate to training of an AI structure for use in the AI operation as well as to executing an already trained AI structure as part of the AI operation.

According to various aspects of the method discussed herein, which will be discussed in detail below, the method may comprise generating the test specification at least in part by the network node and/or obtaining the test specification at least in part from a condition generator (CG) function external to the network node or comprised in the network node. This type of CG function will be discussed in more detail below.

The method may furthermore comprise adjusting the test specification in dependence of a response to a previously transmitted test specification, i.e., the methods disclosed herein can be used to successively refine the test specification until a desired amount of data has been identified. In case the test specification also comprises a request for wireless device configuration, then the method can be used with advantage not only to identify relevant data sets in the network, but also to shape the data sets that are gathered, which is an advantage. Thus, the method may also comprise obtaining a test specification comprising a respective configuration to be applied at the wireless device while performing a test according to the test specification.

The test specification may furthermore comprise a sequence of constituent specifications, where each constituent specification in the sequence of constituent specifications comprises a respective configuration to be applied at the wireless device during performing a test according to the constituent specification. Thus, the test specification can be tailored to the particulars of the AI operation and operating scenario. It is appreciated that the mechanism involving a test specification is versatile and easily adaptable to determine data set relevance in many different use cases and for many different types of AI operations.

The method may furthermore comprise generating the test specification based on a pre-determined requirement associated with the AI operation. This allows the system to at least partly generate the test specifications automatically based on one or more pre-determined requirements, which is an advantage. By taking requirements into account, a degree of compatibility of the data set under test can be obtained, which is an advantage. By generating test specifications based on a set of requirements, data sets which are incompatible with the reequipments can be filtered out at an early stage in an efficient manner.

Various tests can be devised, with different degrees of complexity an implied computational burden, and the present disclosure is not limited to any particular test format. However, surprising performance improvements can be obtained even if relatively simple test specifications are used. For instance, the method may comprise obtaining the test specification simply as a test specification comprising one or more specified events to be counted, wherein the test outcome comprises observed occurrences of the specified events, obtaining the test specification as a test specification comprising a target balance of a number of specified events, wherein the test outcome comprises an observed balance of the number of specified events, and obtaining the test specification as a test specification comprising one or more test conditions, where each test condition is a function configured to operate on the data set and to generate a test condition outcome, wherein the test outcome comprises the test condition outcomes.

The method may furthermore comprise obtaining the test specification as a test specification comprising a sample AI structure related to the AI operation. The test outcome then comprises the sample AI structure trained on the data set. The sample AI structure can, for instance, be a small example of the bigger AI structure to be used in the AI operation. By evaluating the results obtained from using the data set under test on this sample AI structure, the performance using the real AI structure can in many cases be estimated. Some more advanced AI operations can also be designed jointly with the test specification AI structure, which opens up many possibilities for AI operation optimization.

The test specification may also comprise an instruction regarding how to obtain the data set at the wireless device. Thus, the test specification can be extended to also comprise elements which shape the obtained data. This increases the versatility of the proposed approach, since it allows the network node not only to determine the relevance of the data set, but also to shape the data set. Similarly, the method may comprise obtaining a test specification comprising an instruction regarding which data set to use at the wireless device out of a number of available data sets at the wireless device. It is appreciated that the wireless device may have more than one data set stored, or be able to obtain more than one data set if instructed to do so. It is an advantage that the network node can use the test specification to also indicate which data set out of such a plurality of data sets to use.

The method may furthermore comprise obtaining the test specification as a test specification comprising one or more conditions on any of; radio conditions at a physical layer (PHY) of the wireless device, radio conditions at a medium access control layer (MAC) of the wireless device, one or more properties of a radio link control (RLC) function of the wireless device, mobility data associated with the wireless device, and/or an age of data samples in a data set stored by the wireless device.

According to further aspects, the method comprises transmitting the test specification from the network node to the wireless device periodically and/or according to a determined schedule. This way the network node can keep its relevance data up-to-date in an automated manner, and become aware of changes in the relevance status of the data sets out in the network. It is also possible to configure the method to comprise receiving the test outcome from the wireless device periodically and/or according to a predetermined schedule and/or in response to the wireless device determining that the test outcome meets with a transmission acceptance criterion comprised in the test specification.

The method may furthermore comprise identifying one or more wireless devices in a set of wireless devices for facilitating the AI operation based on respective test outcomes received from the wireless devices in the set of wireless devices. It may be challenging to identify such devices in a large network with many wireless devices present. The methods disclosed herein offer a convenient and efficient mechanism to identify relevant wireless devices which are suitable for use in an AI operation. The method may furthermore comprise determining whether a specific wireless device is in possession of, or is able to obtain, a data set which satisfies a set of requirements associated with the AI operation.

According to other aspects, the method comprises notifying an external entity in case the data set of the wireless device meets the acceptance criterion for use in the AI operation. The external entity then receives information related to the presence of the wireless device and can take suitable action as a consequence of receiving the information. This wireless device identification can be used to support a network service, where the network node presents wireless devices suitable for taking part in some AI operation to an external entity wishing to perform the AI operation or some operation that depends on the AI operation in some way. The method may also comprise counting and reporting the number of wireless devices in possession of, or able to obtain, respective data sets that meet the acceptance criterion to an external entity.

The object is also obtained by a method, performed in a wireless device, for facilitating an AI operation in a wireless access network. The method comprises receiving a test specification from a network node of the wireless access network, where the test specification defines a test to be performed on a data set of the wireless device, obtaining a candidate data set at the wireless device for possible use in the AI operation, generating a test outcome by performing the test defined by the test specification on the data set, and transmitting the test outcome back to the network node. Thus, in analogy with the advantages discussed above, the wireless device is able to determine the relevance of its associated data set by performing the test according to the test specification. This allows the network to identify wireless devices suitable for use in a given AI operation, to detect relevant data sets available in the network, and generally make AI operations in the network more efficient.

According to some aspects, the method comprises receiving an instruction from the network node to perform at least part of the AI operation based on the data set, and performing the at least part of the AI operation based on the data set. Thus, if the test outcome is positive, there may be a resulting AI operation started which involves the wireless device. It is, however, noted that the methods discussed herein can also be used for other purposes, such as just identifying which wireless devices in a wireless access network that has access to data which may be relevant to a given type of AI operation.

The test specification may, as discussed above, also comprise instructions regarding the obtaining of the candidate data set. This means that the method is also a mechanism which can be used to shape the data sets of the wireless devices in a group of wireless devices. A network node can use this feature to send out test specifications, and the adjust the way data is obtained at the wireless devices until the data sets comply with the test specification in a feedback manner of operation. According to some aspects, the method also comprises obtaining a configuration to be applied at the wireless device while performing the test defined by the test specification on the data set. Thus, the test specification can be used to set up the wireless device in some desired manner while obtaining the data in the data set. This again represents a mechanism which can be used by the network node to control or shape the data in the data set, perhaps to make it more relevant to be used in an intended AI operation.

The test specification may also comprise an acceptance criterion, in which case the method may then comprise transmitting the test outcome to the network node in case the test outcome satisfies the acceptance criterion. This way the network node can place one or more test specifications to lie dormant at the wireless devices, which will periodically or continuously perform the test. As soon as some wireless device discovers that it has a data set that meets the acceptance criterion it will report in, and the AI operation is thereby facilitated. The method may of course also comprise transmitting a negative test outcome report to the network node in case the test outcome does not satisfy the acceptance criterion. The negative test report may also be of value to the network node, e.g., because it indicates that there are wireless devices with data sets that do not meet the current test specification.

The method may also comprise periodically generating a test outcome by performing the test defined by the test specification on a newly obtained data set. This way the network node will receive a test outcome as soon as new data becomes available.

The above-mentioned advantages are also obtained by computer programs, computer program products, wireless devices and network nodes, as will be discussed in more detail below.

### BRIEF DESCRIPTION OF THE DRAWINGS

The present disclosure will now be described in more detail with reference to the appended drawings, where:

FIG. 1 shows an example wireless communication network built around a core network;

FIGS. 2-6 are signaling diagrams illustrating examples of signal exchange in a wireless access network;

FIGS. 7A-B are flow charts illustrating methods;

FIG. 8 schematically illustrates a core network function.

FIG. 9 schematically illustrates processing circuitry; and

FIG. 10 shows a computer program product;

### DETAILED DESCRIPTION

Aspects of the present disclosure will now be described more fully hereinafter with reference to the accompanying drawings. The different devices, systems, computer programs and methods disclosed herein can, however, be realized in many different forms and should not be construed as being limited to the aspects set forth herein. Like numbers in the drawings refer to like elements throughout.

The terminology used herein is for describing aspects of the disclosure only and is not intended to limit the invention. As used herein, the singular forms “a”, “an” and “the” are intended to include the plural forms as well, unless the context clearly indicates otherwise.

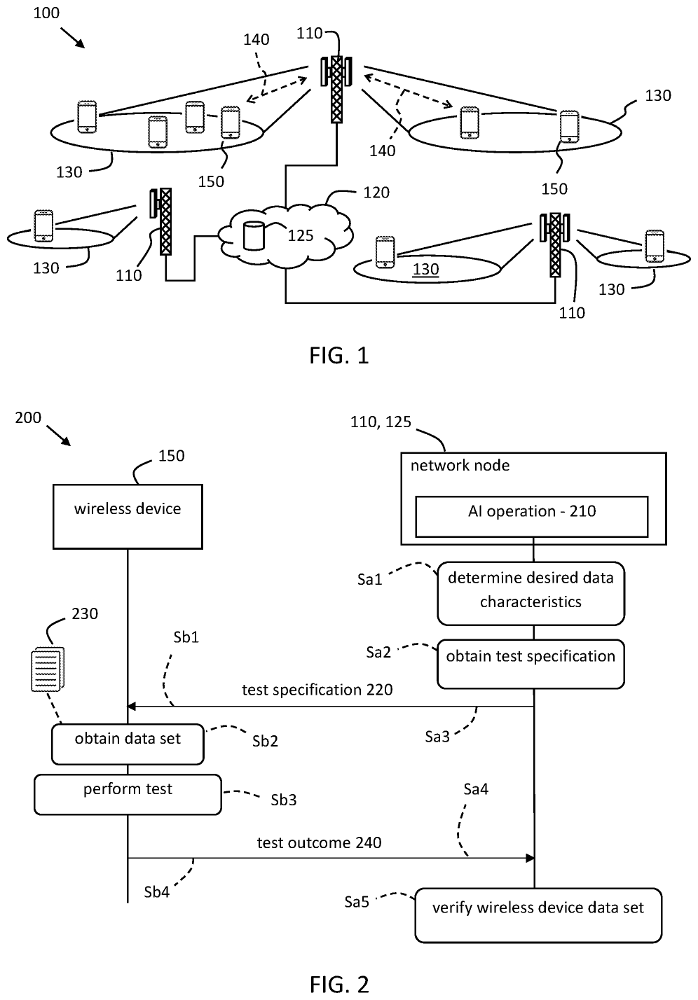

FIG. 1 schematically illustrates an example communication system 100 comprising radio access network nodes 110 (often referred to as gNBs in a 3GPP context) which provide wireless access 140 over a plurality of coverage areas 130. The radio access network nodes are connected to a core network 120. Wireless devices 150 of different types connect to the core network 120 via the radio access network nodes 110. The core network 120 may comprise one or more processing units 125, such as servers, various forms of data processing assets, and also data storage devices.

The communication system may be part of a 5G communication system (5GS) as defined by the 3GPP. However, the techniques disclosed herein are generally applicable, and can be implemented in other communication systems as well, such as a 3GPP 4G system. The techniques are most likely also applicable in future communication systems yet to be deployed, such as a 3GPP sixth generation (6G) communication system.

The wireless communication system 100 is configured to perform one or more AI operations. An AI operation is, as mentioned above, to be interpreted broadly herein to encompass both training of various computational structures such as neural networks, random forest implementations, and the like, and also executing various AI structures, i.e., performing inference based on input data, or the like. No particular distinction will as mentioned above be made herein between ML methods and procedures involving aspects of AI.

As part of the standardization of the fifth generation core (5GC) by the 3GPP, the network data analytics function (NWDAF) was proposed as an interoperable network analytics function. In essence, the NWDAF allows an NWDAF service consumer to subscribe to well-defined events from network functions (NF) (or other analytic functions) and provide data analytics support to a subscriber regarding these events. For example, an analytics function may comprise providing UE mobility prediction to an NWDAF analytics consumer. The NWDAF function is described in detail in 3GPP technical specification (TS) 23.288 V17.0.0. Many of the methods and techniques which will be discussed below can be implemented in the NWDAF framework, to complement and enhance at least some of the functionality offered by NWDAF in a wireless communication system.

When training or executing an AI structure, i.e., when performing an AI operation, it is important that the right type of data is used as input to the structure, since otherwise the intended function may not be obtained from the AI structure, or the desired performance level may not be reached. If the wrong type of data is used to train or execute an AI structure, it cannot be expected to perform very well in its intended task.

For instance, suppose that an AI structure is being trained to predict when a given UE will experience link outage, i.e., when the UE looses the radio link connection to its serving base station, based on some form of radio link quality metric measured by the UE. If this AI structure is trained using data obtained from UEs which always have an exceptionally good radio link quality to their nearest base station and never or only very seldom experience link outage, for instance fixed stations with directive antennas pointing at a radio base station, then it can be assumed that the AI structure will not attain sufficient performance when it comes to predicting link outage. Another example is an AI structure which is to be used in detection of cats in images. In case the AI structure is trained on image data where there are no cats, it is not likely to be able to detect a cat when used in a cat detection application.

To increase the quality of a dataset used in an AI operation, it is known to perform various forms of pre-processing operations, such as a Box-Cox transform or a Yeo-Johnsson transform to bring the data set closer to an independent identically distributed (IID) data set. It is also possible to decrease the dimension of some input feature to reduce computational complexity, which can be done via auto-encoders or the like. However, pre-processing operations can of course never improve AI operation performance if the data set is irrelevant to the AI operation to start with, e.g., does not comprise any cats.

By careful selection of the data set used as input to an AI structure forming part of some AI operation, the performance of the AI model in performing its intended task can be enhanced tremendously. This selection of relevant data can be achieved by some form of expert perspective selection of data from a larger data set, or removal of irrelevant data from a large data set.

The “quality” of a dataset can be measured in several different ways using various known techniques. For instance, drift in the distribution of data in a data set can be indicative of the quality of a data set, the well-known population stability index metric (PSI) and the Kullback-Liebler (KL) divergence metrics are also example metrics which may be indicative of the quality of a data set.

Data set imbalance can also be used to indicate data set quality. For instance, a simple method to evaluate data set quality is to count the number of samples per each class of the input or output of the dataset. Highly unbalanced datasets are often deemed to be of low quality, whereas balanced data sets often result in improved performance of the AI operation.

If there are missing components in the data set, or corrupt data, then the data set is also often said to be of lower quality compared to data sets which are complete and/or does not comprise corrupt entries. For instance, a data set comprising numeric data is often deemed of low quality in case if comprises many “NaN” (not a number) entries.

Correlation and independency between data points in a data set can also be an important measure of data quality.

It may not be easy for a network node 110, such as a gNB or processing asset 125 in the core network 120, in a wireless access network 100, to obtain data suitable for use in an AI operation. There may be several hundreds or even thousands of possible data sources to tap data from, but only a few of these data sources may possess or be able to obtain data which can facilitate the planned AI operation, or even enable it. To help the network node 110, 125 in obtaining a suitable data set for the planned AI operation, the present application proposes a method where the network node or some other wireless access network entity issues a test which the data sources can perform locally on their respective data sets, or on the data sets they are able to obtain should the need arise. The test outcome then indicates if a given data source has relevant data which could be use with advantage in the AI operation or not. The test specification can be designed such that it does not consume significant signaling overhead in the network, and can therefore be communicated by a large number of potential data sources. According to some aspects, only the wireless devices that generate a positive test outcome will respond back, thus ensuring that signaling overhead is kept at a reasonable level. This way the network node can search for suitable data sets, and/or suitable data sources, to use in a planned or ongoing AI operation in an efficient manner.

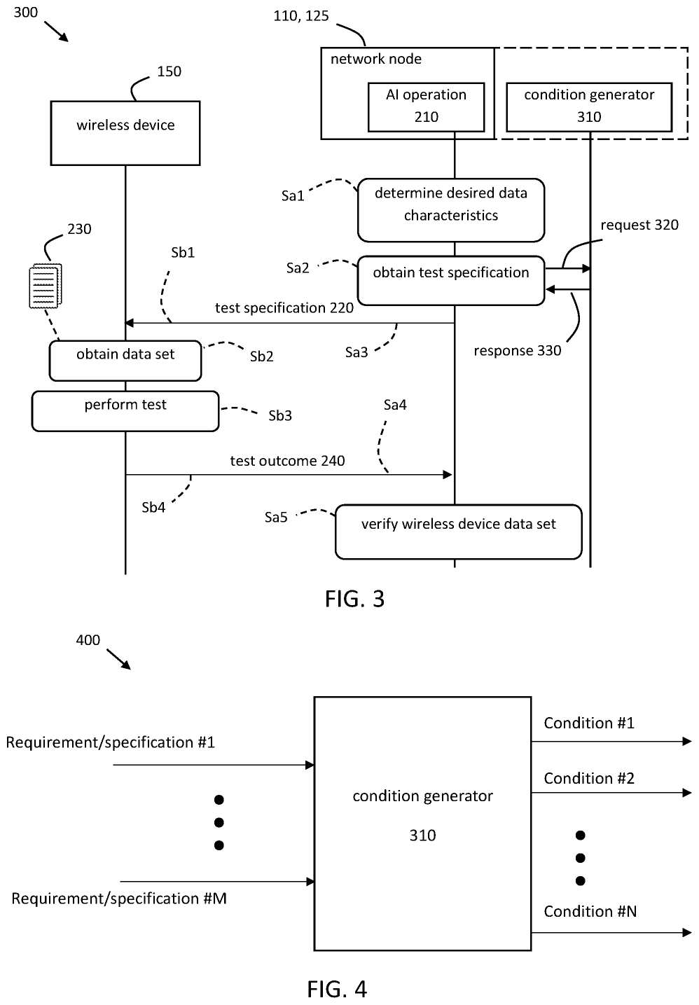

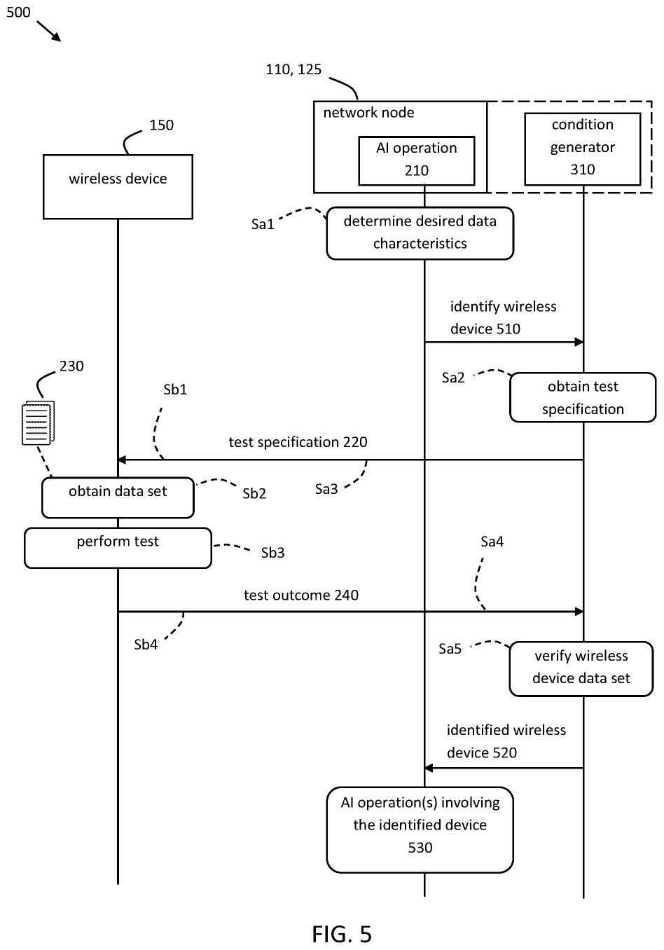

FIG. 2 illustrates the main parts of the proposed procedure. FIGS. 7A and 7B illustrates various aspects of the herein proposed methods as flow charts, where FIG. 7A show operations suitable for performing at the network side, and FIG. 7B show operations suitable for performing at the data source side, which is normally also the UE-side. FIGS. 3-6 show various extensions of the methods adding more capabilities to the technique. The Figures all illustrate aspects of a method, performed in a network node 110, 125, for facilitating an AI operation 210 in a wireless access network 100. The method in its broadest sense comprises determining Sa1 one or more data set characteristics indicative of a relevance of a data set to the AI operation 210. A data set characteristic is something that describes the data set, such as a metric of some sort or a property which describes the data set in relation to other data sets. Several examples of different data set characteristics will be provided below when the methods are exemplified by more handfast examples. However, for now, suffice it to say that a data set characteristic is a property of a data set which can be used to judge if the data set is relevant to the AI operation at hand or if the data set is not relevant to the AI operation.

According to one example, the relevance Sa11 of the data set to the AI operation 210 relates to training of an AI structure for use in the AI operation 210. The relevance may for instance indicate performance in convergence of the AI structure to a state allowing it to perform a given function or task. A relevant data set thus allows an AI structure to be suitably trained for a given task, while a less relevant data set shows worse performance when it comes to training of one or more AI structures comprised in the AI operation. Connecting back to the example with cats above, a relevant data set would be one which comprises at least a number of examples of cats, while an irrelevant data set is one which does not comprise any cats. The data set characteristic is in this case the presence of cats in the images of the data set.

The relevance Sa12 of the data set to the AI operation 210 may also relate to executing a trained AI structure as part of the AI operation 210. A relevant data set again allows the AI structure to be operated with high performance, i.e., a relevant data set used as input to the AI structure provides the desired function, while a less relevant data set does not provide the intended function, or at least does not result in as high performance of the AI operation compared to the relevant data set. Connecting again to the example with cats, a relevant data set for input to the AI structure could perhaps be a data set comprising images where cats could be found. A data set not comprising any images is not relevant to the AI operation, nor is an image data set where the images is of too poor quality.

The method also comprises obtaining Sa2 a test specification defining a test to be performed on a data set 230 of the wireless device 150, where the outcome of the test is indicative of if the data set of the wireless device 150 has the one or more data set characteristics. This test specification describes one or more operations, possibly in sequence, which is to be performed on a data set in order to determine whether the data set is likely to be relevant to the AI operation or not. The test specification basically stipulates a test which is designed to show if a given data set has the one or more data set characteristics discussed above. The test specification may comprise one or more conditions that can be evaluated for a given data set. A data set fulfilling all the conditions can then be associated with a positive test outcome.

Some examples of the contents of a test specification will now be given, and more examples will be provided further below. The method may for instance comprise obtaining Sa219 a test specification comprising an instruction regarding how to obtain the data 230 set at the wireless device 150. This type of test specification can be just a list of steps to take in order to obtain the data items forming the data set, or some more advanced instruction comprising, e.g., triggers and events which are to generate some form of response by the wireless device. Since a wireless device 150 may be in possession of several data sets, the method may comprise obtaining Sa220 the test specification as a test specification comprising an instruction regarding which data set to use at the wireless device 150 out of a number of available data sets at the wireless device 150. Further examples of obtaining Sa221 the test specification comprises obtaining a test specification comprising one or more conditions on any of; radio conditions at a physical layer (PHY), of the wireless device 150, radio conditions at a medium access control layer (MAC), of the wireless device 150, one or more properties of a radio link control (RLC) function of the wireless device 150, mobility data associated with the wireless device 150, and/or an age of data samples in a data set stored by the wireless device 150.

According to an example, the network node sends conditions as part of the test specification to the wireless device in order to measures its capabilities under some specific radio operation mode, e.g., a UE operating in Discontinuous Reception (DRX) and/or Discontinuous Transmission (DTX). Only UEs which are operating in DTX/DRX mode will then obtain a positive test outcome. The network node may also specify that a UE is to obtain data in the data set during a wake-up period or sleep period of DRX/DTX operation.

The test specification 220 is transmitted Sa3 to the wireless device 150 which receives the test specification. The method may comprise transmitting Sa31 the test specification 220 from the network node 110, 125 to the wireless device 150 periodically and/or according to a determined schedule. Thus, the network node can be set up to poll a given wireless device, or group of wireless devices, in order to detect when one or more of the wireless devices obtains a positive test outcome.

The wireless device 150 performs a method matched to the method performed by the network node 110, 125, as illustrated in FIG. 2. Once the wireless device 150 has received Sb1 the test specification 220 from the network node 110, 125 of the wireless access network 100, it is in position to perform a test according to the test specification in order to determine the relevance of the data set it possesses or will obtain at some future point in time. The wireless device 150 obtains Sb2 a candidate data set 230 for possible use in the AI operation, and then generates Sb3 a test outcome 240 by performing the test defined by the test specification on the data set 230. Once the test has been completed, the test outcome 240 is transmitted Sb4 back to the network node 110, 125.

The network node, in turn, receives Sa4 the test outcome 240 sent from the wireless device 150, and verifies Sa5 if the data set of the wireless device 150 meets an acceptance criterion for use in the AI operation, based on the received test outcome 240. 18. The method may comprise receiving Sa41 the test outcome 240 from the wireless device 150 periodically and/or according to a predetermined schedule and/or in response to the wireless device determining that the test outcome meets with a transmission acceptance criterion comprised in the test specification.

According to some aspects, the method also comprises notifying Sa6 an external entity in case the data set 230 of the wireless device 150 meets the acceptance criterion for use in the AI operation 210. The external entity may then take some sort of action, such as obtaining the data set, downloading an AI structure to be trained to the wireless device, or some other form of action. The external entity may, for instance, be part of the NWDAF architecture discussed above. The external entity may also form part of an operations and maintenance function (OAM) in the wireless communication system 100.

According to some other aspects of the herein discussed techniques, the method comprises counting and reporting Sa7 a number of wireless devices in possession of, or able to obtain, respective data sets that meet the acceptance criterion to an external entity. The reporting optionally also comprises wireless device identification data, allowing the external entity to engage directly with the reported wireless devices, or indirectly via some intermediary device.

An in-depth discussion on the verification part Sa5 of the method will be given below. This is an interesting part of the method, which, together with the design of the test specification can be used to shape the input data used by the AI operation. By carefully tuning the test specification, and using the received test outcomes from one or more wireless devices as basis for selecting data sets for use in the AI operation, the efficiency and the performance of the AI operation can be increased tremendously. On one hand, the method allows for optimization of the input data by selecting only the most relevant data sets available for use in the AI operation. On the other hand, the test outcomes can be used also to determine if it is suitable to operate a given AI procedure in a wireless system at all. If no test outcomes are received which indicate at least some rudimentary level of relevance, then it may be better to skip the AI operation entirely.

The outcome of the verification part Sa5 of the method can be seen as a triggering part for performing one or more actions, such as performing Sa8 at least part of the AI operation 210 and/or instructing Sa9 the wireless device 150 to perform at least part of the AI operation 210, conditioned on that the data set of the wireless device 150 meets the acceptance criterion. Some AI operations may involve processing solely at one or more network nodes 110, 125, while other operations are performed only at one or more wireless devices 150. Other AI operations are distributed over both one or more wireless devices and one or more network nodes in a distributed manner. The teachings herein are applicable to all of these examples. Thus, there is a clear technical effect associated with the step of verifying, in that it acts as a triggering point to which one or more actions can be associated. In case the verification outcome is positive, then effort may be spent in one or more operations involving the data set, while if the verification outcome is negative this effort can be saved and instead spent on other data sets more likely to give a desired result.

With particular reference to FIG. 7B, the method optionally comprises obtaining Sb11 a test specification comprising instructions regarding the obtaining at the wireless device 150 of the candidate data set. This means that the test specification not only defines what metrics and other data set characteristics to use when evaluating relevance, but may also define how to obtain the data items in the data set. This instruction may, e.g., comprise timing data indicating when a given operation is to be performed, frequency data indicating at which frequency band a given operation is to be performed, or even some form of configuration Sb12 to be applied at the wireless device 150 while performing the test defined by the test specification on the data set 230, such as a DTX/DRX mode of operation, a particular antenna configuration, or a given power management mode of operation.

Given a test specification, the wireless device 150 may be configured to periodically generate Sb31 a test outcome by performing the test defined by the test specification on a newly obtained data set 230. The wireless device thus periodically “polls” the currently available data set or data sets to see if it may be relevant to the AI operation 210 associated with the test specification. The test outcomes may be transmitted back to the network node 110, 125 as they are generated, or they may be filtered if some acceptance criterion has also been configured by the wireless device 150.

The test specification optionally also comprises Sb13 an acceptance criterion, and the method further comprises transmitting Sb41 the test outcome to the network node 110, 125 in case the test outcome satisfies the acceptance criterion. This is an interesting feature since it allows the network node to download test specifications together with acceptance criteria to a larger number of wireless devices. When one or more of these wireless devices determines that it has a data set which is deemed relevant to the AI operation, then it may notify the network node of the fact, e.g., by communicating the test outcome back to the network node. Thus, akin to fishing, the network node may place a large number of hooks out in the sea of wireless devices, and receive notice when one or more of the wireless devices determine that it has a data set which could be relevant to the AI operation in question. The method optionally also comprises transmitting Sb42 a negative test outcome report to the network node 110, 125 in case the test outcome does not satisfy the acceptance criterion. This report may also be valuable to the network node, for instance in determining how many wireless devices that have been queried, or to detect if there are groups of wireless devices with data sets that do not meet the acceptance criteria.

The method may also comprise receiving Sb5 an instruction from the network node to perform at least part of the AI operation based on the data set, and performing at least part of the AI operation based on the data set.

To summarize, the techniques disclosed herein enables a network entity (e.g., a gNB) to judge wireless device compliance with a given AI operation by defining a test specification, such as a set of conditions about its data, e.g., data quality, stability, and distribution characteristics. In this context, a network entity that is handling a certain functionality or procedure based on AI, is extended with the capability of (i) obtaining a certain set of conditions related to data to be used for a certain AI model (either by generating such conditions directly or by receiving them by another entity), (ii) requesting and obtaining from a wireless device information related to such conditions and (iii) checking whether the conditions are satisfied by the wireless device so that the wireless entity could understand whether the wireless device can participate in that specific AI procedure, e.g., provide the AI model to the wireless device.

With this type of solution implemented in the wireless communication system 100, the network obtains the capability to gather data set related information of from one or more wireless devices in an efficient manner. This allows the network to understand (i) whether a wireless device has a data set which matches the needs of the considered AI model, and (ii) whether a certain AI model should be provided to a certain wireless device as the quality of its data set is high and consequently the overall model could benefit from training performed by such wireless device.

The methods disclosed herein provides a network node with more and better information allowing the network node to understand whether a certain wireless device should perform model updates as part of the AI operation or not. In addition, the technique can be considered as a building block for upcoming network functionalities aimed at having a smarter selection of wireless devices to which a certain AI model should be provided for local training/update which could also give the benefit of requiring model updates from fewer wireless devices with consequent benefits in terms of less signaling.

The test specification can be generated Sa210 at least in part by the network node 110, 125, and in various different ways. The method may, for instance, comprise obtaining Sa211 the test specification at least in part from a condition generator (CG) function 310 external to the network node 110, 125 or comprised in the network node 110, 125. FIG. 3 shows an example sequence of operations 300 involving such a CG function 310. As part of obtaining Sa2 the test specification, a request 320 for a test specification is sent to the CG 310, which responds back 330 with a generated test specification.

FIG. 4 shows an example 400 of a condition generator function 310. This example condition generator function 310 if configured to receive one or more requirements or specifications and generates conditions which can be imposed on a data set as part of the test specification based on the requirements and/or specifications. FIG. 4 also relates to the feature of generating Sa214 the test specification based on a pre-determined requirement 640 associated with the AI operation 210, which will be discussed in more detail below in connection to FIG. 6.

The additional information provided alongside the request from the AI operation 210 to the CG 310 may for instance comprise high level requirements or specifications that the CG can use to generate conditions which can then be imposed on a data set under test. The conditions to impose on the data set may form part of the test specification, or form part of the one or more data set characteristics which are indicative of relevance to the AI operation.

Some approaches for such a mapping are listed below:

Assuming that the AI operation 210 requires dual connectivity (DC) and or carrier aggregation (CA), the CG 310 determines the need for training data with more than a given number x of samples, non-skewed and/or non-biased distribution (balanced distribution), and a specific condition on allowable data drift. The CG 310 sends the set of conditions to the wireless device as part of the test specification and requests it to perform a compliance check, i.e., to generate a test outcome.

For further elaboration, assume that the wireless device throughput was not enough, hence CA for throughput boosting is required, or that a block error rate (BLER) target was not achieved via conventional physical layer (PHY) means, then CA is triggered. Then, the wireless device is required to perform some measurements of reference signal received power (RSRP) on the secondary cell (for CA) or secondary transmission site (for DC).

The age of the data in the data set is another data characteristic that can be considered when mapping requirements to conditions which then form part of the test specification. If a requirement of the AI operation 210 considers the time stamp of the last updated RSRP prediction model to be some x.y.z slot, it can be mapped to a condition where the wireless device has RSRP data for training/updating at least comprising said x.y.z slot. In relation to the second point, the network node could potentially also send an alternative to the wireless device, stating that if such age condition is not possible for RSRP prediction, is it possible for alternative-y, e.g., reference signal received quality (RSRQ)? signal-to-interference and noise ratio (SINR)?. The gNB could also characterize the condition to wireless devices by identifying the usage of such data for either training for key performance indicator (KPI) prediction (e.g., RSRP) or updating, or simply for inference.

Referring again to FIG. 4, a difference between conditions (output from the CG function 310) and requirements (input to the CG function 310) are that conditions form a set of logical statements (can be with thresholds) that are sent to the wireless device as part of the test specification. A test specification may then, in addition to the actual metric, also comprise any of a logical expression, an equation, whether config x is set, whether parameter x has a value or not, etc. Requirements on the other hand are used to generate conditions and are fetched from either the CG 310 or from another entity in the network. Such requirements may be dependent on the use-case, on the type of wireless device, and also on other factors.

Some example-requirements: meeting specific AI operation KPI requirements, such as training efficiency, generality, and quality requirements. For example, a system designer could require an AI operation which can be generalized to factory and highway.

Some example conditions: based on the above generality requirement, the condition entity will fetch such requirements from the requirement generating/catalogue entity. Then the condition generator entity would map such requirement to condition on the number of samples of factory and highway which must be (at least) used by the procedures (UE/gNB) to train the AI structure.

Referring again to FIG. 7A, the method may comprise adjusting Sa212 the test specification in dependence of a response to a previously transmitted test specification. This means that the network node may probe the wireless system 100 to determine the degree of relevance of the data sets available therein. Suppose that some network node, user, or function identifies a need to perform an AI operation, and consequently also identifies a need to obtain data to perform the AI operation. The network node may then compose a test specification and send it out to wireless devices in the network. The test specification or specifications sent out in the network are likely to generate at least some test outcomes which are received back at the network node. Observing these test outcomes, the network node may adjust the test specification to determine if the adjusted test specification yields more relevant data sets compared to the previously transmitted test specifications. This way the network node can determine a suitable ambition level, given the current availability of data sets to operate on in the wireless communication system, and/or the ability of wireless devices in the wireless communication system to obtain relevant data if instructed to do so.

Along a similar line of reasoning the network node may also adjust the acceptance criteria applied in analyzing the test outcomes, e.g., in connection to the feature related to test specifications comprising acceptance criteria which can be used to trigger reporting. This way the network node can control the amount of data sets available to it. For instance, suppose that a wireless device reports back if and only if it determines that it has a relevant data set, as determined by comparing the test outcome to the acceptance criterion comprised in the test. Then, by adjusting said acceptance criterion, the amount of reports can be adjusted to a suitable level which balances network signaling overhead and data set size.

The method may furthermore comprise obtaining Sa213 a test specification comprising a respective configuration to be applied at the wireless device 150 while performing a test according to the test specification. This allows the network node to also configure the wireless device in certain ways, such that the desired type of data is obtained. The test specification may even comprise Sa2131 a sequence of constituent specifications, where each constituent specification in the sequence of constituent specifications comprises a respective configuration to be applied at the wireless device during performing a test according to the constituent specification.

According to other aspects, the method comprises obtaining Sa215 a test specification comprising one or more specified events to be counted, wherein the test outcome 240 comprises observed occurrences of the specified events. This is a rather simple form of test, where the data source, i.e., the wireless device, is asked to note how many times a given event has happened. If the event happens often enough (or seldom enough), then the data set may be relevant to the AI operation 210. For instance, connecting back to the discussion on AI operations configured to predict link outage, it may be more relevant to use wireless devices which experience link outage often compared to wireless devices which do not experience link outage very often. A data set characteristic indicative of relevance to the AI operation may therefore just be the occurrence or absence of some type of specified event. According to further aspects, the method comprises obtaining Sa216 a test specification comprising a target balance of a number of specified events, wherein the test outcome 240 comprises an observed balance of the number of specified events.

The methods disclosed herein can also be used to identify one or more wireless devices 150 out of a larger group of wireless devices for partaking in the AI operation 210, e.g., by using data sets obtained by the wireless devices. FIG. 5 illustrates an example 500 where the AI operation 210 or some other function at the network node submits a request 510 to the condition generator 310 or to some other module asking the module to identify one or more suitable wireless devices for use in the AI operation 210. The condition generator 310 then composes a test specification tailored for the task of identifying suitable wireless devices for the given AI operation, and then proceeds to analyze the test outcomes received from the wireless device. The identified wireless device or devices are then reported back 520 to the AI operation 210, which can then proceed with the AI operations 530. Thus, the method may comprise identifying Sa51 one or more wireless devices 150 in a set of wireless devices for facilitating the AI operation 210 based on respective test outcomes received from the wireless devices in the set of wireless devices.

The same mechanism can of course also be used to determine Sa52 whether a specific wireless device 150 is in possession of, or is able to obtain, a data set 230 which satisfies a set of requirements 640 associated with the AI operation 210, as illustrated by the example signaling diagram 600 in FIG. 6.

To summarize at least part of the discussions up until now, there has been presented a method which can be used to identify a suitable wireless device 150 to be used in some form of AI operation 210 at the network side considering the characteristics/properties of the data/features that it has and/or can produce. The technique introduces new signaling and processing methods to make it possible for an AI operation 210 executing at a network node to assess if a wireless device 150 has or can produce a high quality data set which at the same time is relevant to the AI operation 210.

For example, the AI operation 210 may first generate one or more conditions related to quality of the data to be used in its application that needs to be checked at one or more wireless device 150s. In another example the conditions are fetched from a logically separate entity (the CG function 310) as shown in, e.g., FIG. 6. The generated test specification is transmitted to one or more wireless device 150 from the network node, i.e., from the gNB or from some other processing asset in the network involved in the AI operation 210. The wireless device 150, having received the request, evaluates any conditions forming part of the test specification, generates a test outcome, and then submits the test outcome back to the network node.

The testing conditions in one option rely on stored data sets at the wireless device 150 side. Thus, according to one example the wireless device 150 already has a data set, and the network is aware of the specifics (e.g., in wireless device 150 capability information reporting procedures). The network entity may then indicate to the wireless device 150 which data set to use in the test, in case the wireless device 150 has more than one data set available, or is able to obtain more than one data set, perhaps using different wireless device 150 configurations.

According to another example the network entity preventively configures the wireless device 150 to store desired data such as RSRP, UE speed, UE location, BLER, etc. for a certain period prior to sending the test specification to the wireless device 150.

According to yet another example, the network entity configures the wireless device 150 to store required data upon sending the test specification. In this case the wireless device 150 first starts collecting data according to the configuration and once finished starts evaluating the conditions comprised in the test specification and reports the test outcome back to the network node. The wireless device 150 can also perform the test according to the test specification without having to store the data, instead using online equations to evaluate the various conditions. For example, the test condition may concern calculation of an average value, which can be updated without having access to the entire data set.

Several examples of wireless device compliance testing will now be given, for different use cases targeted at different layers and functions of radio interface.

The data compliancy check can comprise aspects related to radio conditions at PHY. For example, the gNB may be interested in training an AI model for detecting a radio link failure (RLF) before it happens (temporal prediction). An RLF occurs when the wireless link becomes so weak that the wireless device 150 cannot reliably decode the control channels anymore. To detect an RLF the wireless device 150 monitors the radio link for out-of-sync (OOS) (corresponds to an event where BLER exceeds 10%) and in-sync (IS) (corresponds to an event where BLER goes below 1%) events. If a certain number of OOS sync events occur and the wireless device 150 cannot recover from it (i.e., certain number of IS does not occur) an RLF is declared. Meaning that the wireless device 150 will not be able to reliably decode the control channels and hence it is an indication that the connection is lost. This is a low probability event and not all wireless devices 150 are suited to be used here. Hence, here the quality of the data pertains to OOS, IS and RLF events. The following test conditions can be generated to be evaluated in each wireless device 150.

According to a first option, the test specification has a single test condition. For example, the network signals to the wireless device 150 to record the number of RLF events that is occur in a given intervals of T seconds. If the number of RLF events in this period exceeds the threshold then the condition test succeeds, i.e., then the test outcome is positive.

According to a second option, the test specification comprises more than one condition to evaluate. For example, the network may be interested to find radio failures that represent anomalies, meaning that they occur even when radio condition is good (e.g., despite a UE having a high RSRP value). A test condition here can be defined as the number of RLF events exceeding a threshold while a measured RSRP value is above a threshold provided as part of the test specification.

According to a third option, the test specification defines a test which is configured to evaluate if the wireless device 150 can produce a data set satisfying a certain balance. To assess the balance of recorded data set the network may set the condition that the number of RLF events should be larger than X percent of the total number of entries in the data set. This approach also helps if the AI model is interested in data compliancy related to rare events.

According to a fourth option the network may want to also assess if there are certain number of entries in a given data set. This query can be further combined with a previous condition to make a multiple criterion test. For instance, a first test condition can relate to the percentage of RLF event entries in a data set, and a second test condition can relate to the total number of entries.

According to a fifth option the test specification can comprise aspects related to timing. For example, if the wireless device 150 can produce a certain number of entries within T seconds.

According to some aspects, the data compliancy check is at least partly performed with respect to radio conditions at the medium access control (MAC) layer. Continuing from the RLF case discussed above, there are also procedures in the specification to detect failures at the MAC layer. With the introduction of beam based new radio (NR), new mechanisms to control which beam the wireless device 150 is connected to also have been implemented. However due to movement of the wireless devices in the network there may be a need to perform beam handover for some wireless devices. This is not a perfect method and sometimes a wireless device loses a beam without being able to find a suitable new beam to use. In this case a so-called beam failure occurs, and the wireless device 150 needs to perform a beam failure recovery (BFR) operation. Similar to a PHY RLF event, each wireless device 150 experiences different statistics. Stationary (slow moving) wireless devices may not experience beam failure at all while other wireless devices which move fast, experience it more frequently. Thus the network may want to identify those wireless devices that can generate sufficient data related to beam failure such as beam failure indication (BFI) and related timers.

According to yet another example the test conditions in the test specification are related to the RLC layer. Another case of connection failure happens when a wireless device 150 experiences an excess number of retransmissions at the RLC layer. When the number of retransmissions at the RLC layer exceeds a certain threshold, a failure is declared. Like the previously discussed cases the methods disclosed herein can be used to identify which wireless devices that can be used to efficiently train an AI model related to this problem.

Data compliancy with respect to mobility measurements can also be considered as part of the framework. The test conditions comprised in the test specification are then used at least in part to identify compliant wireless devices with respect to mobility measurements. In 3GPP NR and also in 3GPP long term evolution (LTE), the radio resource control (RRC) protocol has a measurement procedure where the gNB configures the wireless device 150 to detect cells on a given frequency and report relevant quantities such as RSRP/RSRQ/SINR to be used in mobility management functions. Test conditions may for instance be formulated on the mobility pattern of a wireless device, handover patterns of a wireless device, and so on. Another criterion for testing could pertain to location, i.e., being able to possess or generate data pertaining to a specific geographical location. For example, an AI model that is being trained for detection of a certain QOS degradation in special geographical area. A test condition can be sent to the wireless device 150 to see whether it passes/resides the geographical location of the interest. In this example it would be meaning less to include wireless devices who are not (and will not be) part of the geographical area in the AI task. The same goes with inference task. It would be futile to detect QoS degradation for some specific area where wireless device 150 does not belong to.

The network may also require different data associated with different subcarrier spacings. Different subcarrier spacings correspond to different transmission time slot durations. This has an impact that could propagate up to transport layer protocols. The techniques disclosed herein help to identify those wireless devices who possess various data in different layers associated with different subcarrier spacings. An AI model that is interested in optimizing network configurations for application layer performance could be interested to use wireless devices that is in possession of data associated with different subcarrier spacing.

In another example, the network wants to optimize the experience of the cell edge wireless devices and tests whether the wireless device 150 can generate data of interest (e.g., RSRP for mobility optimization) while being in the cell edge for at least T seconds.

FIG. 6 illustrates aspects of the method where the network node CG entity 310 sends and receives signals to and from a “Data Catalogue” or “Requirement catalogue” function 610, inquiring about existing models and associated data for its AI operations 210, which correspondingly need to be met by wireless device 150 AI capabilities. The requirement catalogue 610 fetches existing and recommended models, its characteristics, and responds with data requirement to update, then send those to the CG entity 310. The CG 310 uses this input to generate the test specification which it sends to the wireless device 150. According to one option, the network node (e.g., the CG 310) sends requests to the requirements catalogue 610 inquiring about, e.g., its registered AI procedures, models used, processing requirements of the models, and so on.

According to one example, the AI operation 210 obtains the set of conditions and directly signals a test specification comprising the test conditions to the wireless device 150 for testing. According to another example the CG entity 310 signals the conditions to the wireless device 150 for testing. According to yet another example the network entity hosting the AI procedure signals the conditions to the wireless device 150 for testing. The network entity hosting the CG can of course also signal the conditions to the wireless device 150 for testing.

A library of wireless devices who are capable and willing and allowed by the network to participate in AI procedures can be maintained (e.g., in network entity hosting the AI procedure or CG) to speed up condition testing at wireless device 150s

Optionally, whenever an AI capable wireless device 150 connects to the network, the data catalogue function 610 is updated. For example, if an AI capable wireless device 150 registers to the network, the access and mobility management function (AMF) may signal the library of the data catalogue function 610 to be updated with the information of that wireless device 150.

In another option, whenever an AI capable wireless device 150 leaves the network (e.g., wireless device 150 going to IDLE and unregisters from core network) the library in the data catalogue function 610 is updated, and that wireless device 150 is removed from it. The network may also dynamically send configuration information of the AI capable wireless devices to be used (e.g., by the CG) to update the data catalogue function 610. For example, due to low power the network signals the CG to toggle that wireless device 150 in the data catalogue function 610 as unavailable.

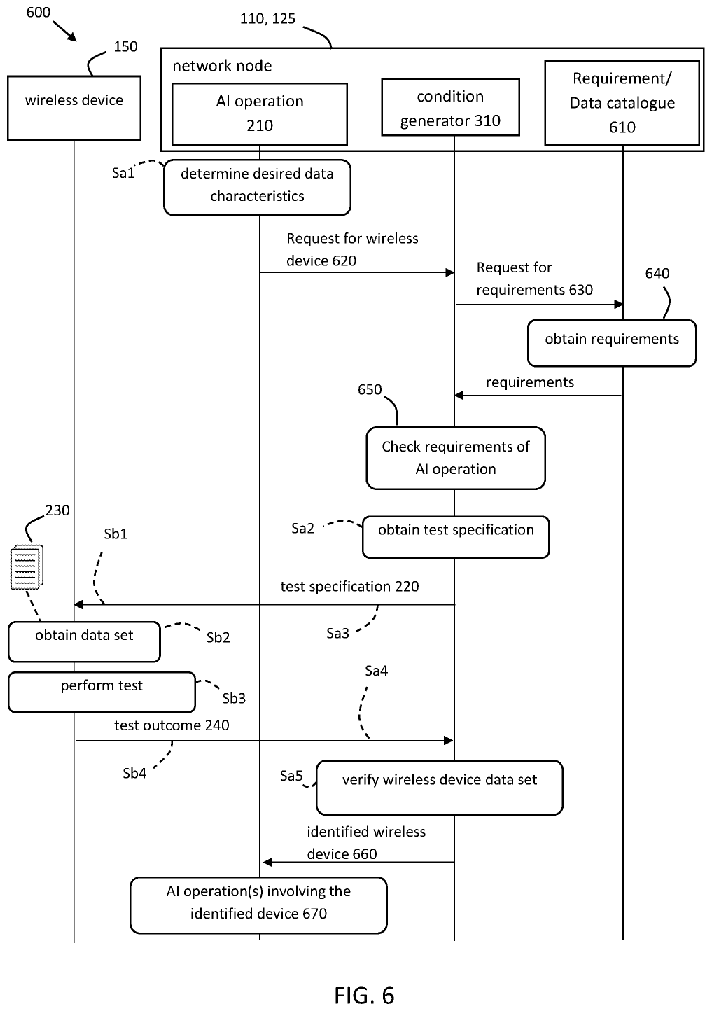

FIG. 8 illustrates various realizations 800 of the methods discussed above. The methods and receivers discussed above may be implemented in a 5GC node which could be deployed in a centralized manner or in a virtual node in the communications network 100. The split between the physical node and the centralized node can be on different levels. Parts of the proposed methods may of course also be implemented on a remote server comprised in a cloud-based computing platform.

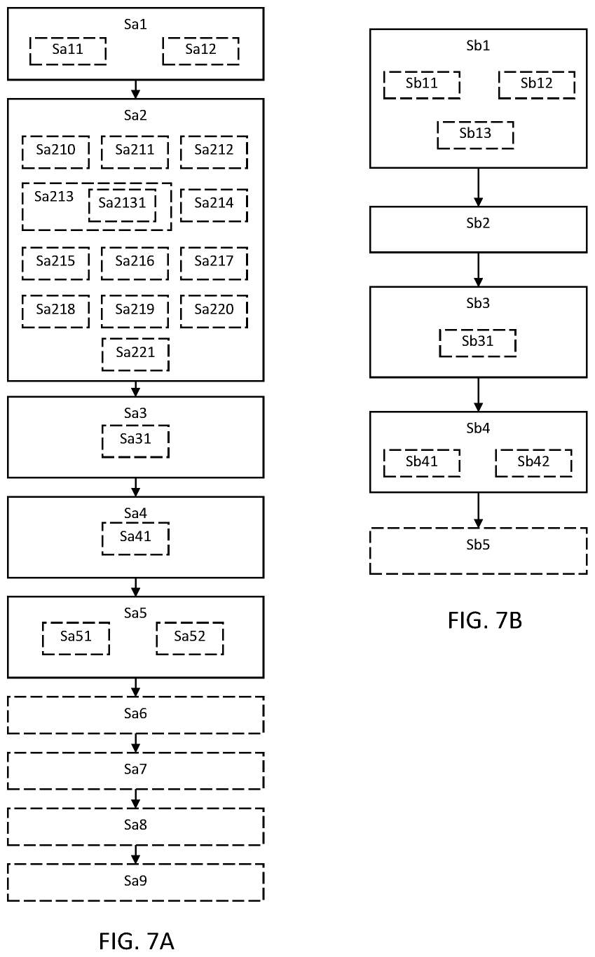

FIG. 9 schematically illustrates, in terms of a number of functional units, the general components of a network node 900 according to embodiments of the discussions herein. Processing circuitry 910 is provided using any combination of one or more of a suitable central processing unit CPU, multiprocessor, microcontroller, digital signal processor DSP, etc., capable of executing software instructions stored in a computer program product, e.g., the form of a storage medium 930. The processing circuitry 910 may further be provided as at least one application specific integrated circuit ASIC, or field programmable gate array FPGA.

Particularly, the processing circuitry 910 is configured to cause the device 900 to perform a set of operations, or steps, such as the methods discussed in connection to FIGS. 7A and 7B and the discussions above. For example, the storage medium 930 may store the set of operations, and the processing circuitry 910 may be configured to retrieve the set of operations from the storage medium 930 to cause the device to perform the set of operations. The set of operations may be provided as a set of executable instructions.

Thus, the processing circuitry 910 is thereby arranged to execute methods as herein disclosed. In other words, there is shown a network node 1900, comprising processing circuitry 910, a network interface 920 coupled to the processing circuitry 910 and a memory 930 coupled to the processing circuitry 910, wherein the memory comprises machine readable computer program instructions that, when executed by the processing circuitry, causes the network node to execute one or more of the operations, functions and methods discussed herein.

The storage medium 930 may also comprise persistent storage, which, for example, can be any single one or combination of magnetic memory, optical memory, solid state memory or even remotely mounted memory.

The device 900 may further comprise an interface 920 for communications with at least one external device. As such the interface 920 may comprise one or more transmitters and receivers, comprising analogue and digital components and a suitable number of ports for wireline or wireless communication.

The processing circuitry 910 controls the general operation of the device 900, e.g., by sending data and control signals to the interface 920 and the storage medium 930, by receiving data and reports from the interface 920, and by retrieving data and instructions from the storage medium 930. Other components, as well as the related functionality, of the control node are omitted in order not to obscure the concepts presented herein.

FIG. 9 schematically illustrates a network node 110, 125, for facilitating an AI operation 210 in a wireless access network 100. The network node comprises processing circuitry 910; a network interface 920 coupled to the processing circuitry 910; and a memory 930 coupled to the processing circuitry 910, wherein the memory comprises machine readable computer program instructions that, when executed by the processing circuitry, causes the network node to:
determine one or more data properties indicative of a relevance of a data set to the AI operation 210, obtain a test specification defining a test to be performed on a data set 230 of the wireless device 150, where the outcome of the test is indicative of if the data set of the wireless device 150 has the data properties,
transmit the test specification 220 from the network node 110, 125 to the wireless device 150,
receive a result of the test performed on the data set 230 of the wireless device 150 as a test outcome 240 from the wireless device 150, and
verify if the data set of the wireless device 150 meets an acceptance criterion for use in the AI operation, based on the received test outcome.

FIG. 9 also schematically illustrates a wireless device 150, for facilitating an AI operation 210 in a wireless access network 100. The wireless device comprises processing circuitry 910; a network interface 920 coupled to the processing circuitry 910; and a memory 930 coupled to the processing circuitry 910, wherein the memory comprises machine readable computer program instructions that, when executed by the processing circuitry, causes the wireless device to:
receive a test specification 220 from a network node 110, 125 of the wireless access network 100, where the test specification defines a test to be performed on a data set 230 of the wireless device,
obtain a candidate data set 230 at the wireless device 150 for possible use in the AI operation,
generate a test outcome 240 by performing the test defined by the test specification on the data set 230, and
transmit the test outcome 240 to the network node 110, 125.

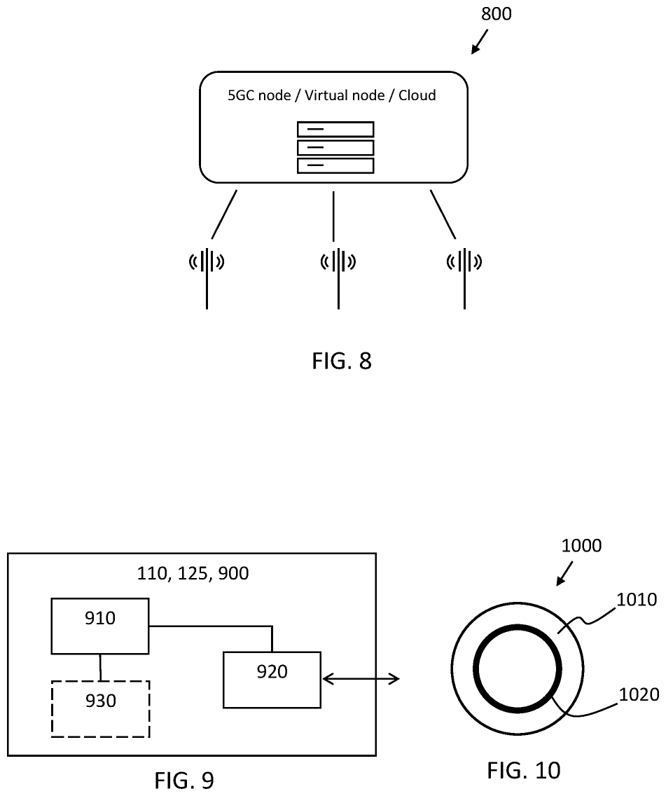

FIG. 10 illustrates a computer readable medium 1010 carrying a computer program comprising program code means 1020 for performing the methods illustrated in, e.g., FIG. 7A and FIG. 7B, when said program product is run on a computer. The computer readable medium and the code means may together form a computer program product 1000.

1.-36. (canceled)

37. A method, performed in a network node, for facilitating an artificial intelligence (AI) operation in a wireless access network, the method comprising
determining one or more data set characteristics indicative of a relevance of a data set to the AI operation,
obtaining a test specification defining a test to be performed on a data set of the wireless device, where the outcome of the test is indicative of if the data set of the wireless device has the one or more data set characteristics,
transmitting the test specification to the wireless device,
receiving a result of the test performed on the data set of the wireless device as a test outcome from the wireless device, and
verifying if the data set of the wireless device meets an acceptance criterion for use in the AI operation, based on the received test outcome.

38. The method according to claim 37, further comprising performing at least part of the AI operation and/or instructing the wireless device to perform at least part of the AI operation, conditioned on that the data set of the wireless device meets the acceptance criterion.

39. The method according to claim 37, comprising obtaining the test specification at least in part from a condition generator (CG) function external to the network node or comprised in the network node.

40. The method according to claim 37, comprising adjusting the test specification in dependence of a response to a previously transmitted test specification.

41. The method according to claim 37, comprising obtaining the test specification as a test specification comprising a respective configuration to be applied at the wireless device while performing a test according to the test specification.

42. The method according to claim 41, where the test specification comprises a sequence of constituent specifications, where each constituent specification in the sequence of constituent specifications comprises a respective configuration to be applied at the wireless device during performing a test according to the constituent specification.

43. The method according to claim 37, comprising obtaining the test specification as a test specification comprising one or more specified events to be counted, wherein the test outcome comprises observed occurrences of the specified events.

44. The method according to claim 37, comprising obtaining the test specification as a test specification comprising a target balance of a number of specified events, wherein the test outcome comprises an observed balance of the number of specified events.

45. The method according to claim 37, comprising obtaining the test specification as a test specification comprising a sample AI structure related to the AI operation, wherein the test outcome comprises the sample AI structure trained on the data set.

46. The method according to claim 37, comprising obtaining the test specification as a test specification comprising one or more conditions on any of:
radio conditions at a physical layer (PHY) of the wireless device;
radio conditions at a medium access control layer (MAC) of the wireless device,
one or more properties of a radio link control (RLC) function of the wireless device;
mobility data associated with the wireless device; and/or
an age of data samples in a data set stored by the wireless device.

47. The method according to claim 37, comprising receiving the test outcome from the wireless device periodically and/or according to a predetermined schedule and/or in response to the wireless device determining that the test outcome meets with a transmission acceptance criterion comprised in the test specification.

48. A network node, for facilitating an artificial intelligence (AI) operation in a wireless access network, the network node comprising:
processing circuitry;
a network interface coupled to the processing circuitry; and
a memory coupled to the processing circuitry, wherein the memory comprises machine readable computer program instructions that, when executed by the processing circuitry, causes the network node to:
determine one or more data properties indicative of a relevance of a data set to the AI operation,
obtain a test specification defining a test to be performed on a data set of the wireless device, where the outcome of the test is indicative of if the data set of the wireless device has the data properties,
transmit the test specification from the network node to the wireless device,
receive a result of the test performed on the data set of the wireless device as a test outcome from the wireless device, and
verify if the data set of the wireless device meets an acceptance criterion for use in the AI operation, based on the received test outcome.

49. A method, performed in a wireless device, for facilitating an artificial intelligence (AI) operation in a wireless access network, the method comprising
receiving a test specification from a network node of the wireless access network,
wherein the test specification defines a test to be performed on a data set of the wireless device,
obtaining a candidate data set at the wireless device for possible use in the AI operation,
generating a test outcome by performing the test defined by the test specification on the data set, and
transmitting the test outcome back to the network node.

50. The method according to claim 49, further comprising receiving an instruction from the network node to perform at least part of the AI operation based on the data set, and performing the at least part of the AI operation based on the data set.

51. The method according to claim 49, comprising obtaining the test specification as a test specification comprising instructions regarding the obtaining of the candidate data set.

52. The method according to claim 49, comprising obtaining a configuration to be applied at the wireless device while performing the test defined by the test specification on the data set.

53. The method according to claim 49, wherein the test specification comprises an acceptance criterion, and the method further comprises transmitting the test outcome to the network node in case the test outcome satisfies the acceptance criterion.

54. The method according to claim 53, comprising transmitting a negative test outcome report to the network node in case the test outcome does not satisfy the acceptance criterion.

55. The method according to claim 49, comprising periodically generating a test outcome by performing the test defined by the test specification on a newly obtained data set.

56. A wireless device, for facilitating an artificial intelligence (AI) operation in a wireless access network, the wireless device comprising:
processing circuitry;
a network interface coupled to the processing circuitry; and
a memory coupled to the processing circuitry, wherein the memory comprises machine readable computer program instructions that, when executed by the processing circuitry, causes the wireless device to:
receive a test specification from a network node of the wireless access network, where the test specification defines a test to be performed on a data set of the wireless device,
obtain a candidate data set at the wireless device for possible use in the AI operation,
generate a test outcome by performing the test defined by the test specification on the data set, and
transmit the test outcome to the network node.
